(19) United States
(12) Patent Application Publication
(10) Pub. No.: US 2004/0226156 A1
(43) Pub. Date: Nov. 18, 2004

(54) Tire change apparatus

(76) Inventors: Dan Storey, Idaho Falls, ID (US); Joyce Storry, Idaho Falls, ID (US)

Correspondence Address: Wesley Lang, #850, 50 South Main, Salt Lake City, UT, 84144, US

(21) Appl. No.: 10/846,881

(22) Filed: May 13, 2004

Related U.S. Application Data
(60) Provisional application No. 60/469,954, filed on May 13, 2003.

(51) Int. Cl. B25B 27/14

(52) U.S. Cl. 29/273

(57) ABSTRACT

An apparatus for to assist in the changing of tires on cars, light trucks and heavy trucks. The apparatus assists in raising and lowering the tire and wheel for positioning on the stud bolts, reducing abrasion and wear on the holes in the wheels, and in moving the tire and wheel toward and away from the vehicle.

### BACKGROUND OF THE INVENTION

1. Field of the Invention

The present invention relates to an improved tire changing device and specifically relates to a device which assists in: removing the old tire and rim from the vehicle axle; transporting the old tire and rim away from the vehicle; transporting the replacement tire and rim to the vehicle; and placing the replacement tire and rim into position for easy placement on the axle of the vehicle.

2. State of the Art

Changing a tire is never a welcome experience. It involves a great deal of physical exertion to not only raise the vehicle on the jack and loosen the lug nuts on the old tire, but also to lift the old tire off the lug bolts and to lift the new tire and rim into position and to orient it for placement on the lug bolts. This can be a very difficult and messy task as it is frequently done on the side of the road in the snow or mud. The combination of tire and rim also makes for a heavy weight to lift on and off the lug bolts of the vehicle.

Devices have been designed to assist in lowering and raising a tire. U.S. Pat. No. 3,555,583 to Mousel describes a tire tool comprising a cross wrench with two perpendicularly arranged longitudinal components and having a tire support secured to one of the longitudinal components. The tire can be moved by sliding one end of the tool along the ground with the tire placed on the tire support. While that invention possesses a small roller for maneuvering the tire, its base is really too small to support the tire in a stable fashion and allow it to be readily moved without tipping.

U.S. Pat. No. 5,581,866 to Barkus describes an elongate member designed to fit through the central aperture of a wheel and having an end shaped to rest on the outer surface of the vehicle hub, thus allowing the wheel and tire assembly to be levered onto the vehicle hub and the lug holes to be lined up with the corresponding lug bolts. This invention possesses no means to move the wheel and tire assembly toward or away from the vehicle. In addition, it requires the rather cumbersome expedient of sliding the elongate member through the central aperture of the wheel and then, with the end resting on the hub, levering tire and wheel assembly into place, with the danger that the end will slip off the hub.

U.S. Pat. No. 3,828,95 to Harkey describes a wheeled tire changing tool possessing a platform for supporting the tire at one end, and a handle at the opposite end for manipulating the platform, including moving the tire up and down. A limitation of this invention is that the design of the platform that supports the tire is not sufficient to support the tire in an upright position. In addition, the tires are set too far apart to allow the device to be easily maneuverable.

U.S. Pat. No. 2,207,443 to Schneider describes a wheeled carriage type device having a laterally concave surface to support the tire. The tire is manipulated vertically by means of a hand crank that turns a screw. The screw in turn acts on a lever to move the tire up and down. A limitation of this invention is that it is cumbersome and difficult to maneuver. The need to hand crank the screw to manipulate the tire also makes the device time consuming and difficult to operate.

Due to these concerns, there is a desire to create a device to assist in changing tires that is relatively light weight and easily maneuverable. There is also a desire to create such a device that supports the tire solidly while it is being moved into position and manipulated vertically.

### SUMMARY OF THE INVENTION

Thus, it is an object of the present invention to provide a device to assist in changing tires that is relatively light weight and easily maneuvered.

It is a further object of the present invention to create a device that supports the tire solidly while it is being moved into position and manipulated vertically.

It is a further object of the present invention to create a device that is small enough to fit in the trunk of an automobile.

It is a further object of the present invention to create a device that is heavy duty enough to handle tires an rims that are commonly found on large trucks.

In accordance with a preferred embodiment of the present invention, a device is provided having a first end, comprising a handle and a second end, comprising a cradling member. The cradling member possesses a backstop of sufficient size and angle that it solidly supports the tire being maneuvered. The device also possesses a means of fastening the tire securely to the backstop to prevent it from sliding or rolling off.

This device not only helps prevent back injuries to persons attempting to change tires, but saves wear and tear on the tire rims as they are mounted on or removed from the lug bolts. Large rims, such as those found on semi trucks, are frequently made of aluminum or chrome which are fairly soft metals. The traditional method of removing or placing these wheels on the lug bolts involves allowing most of the weight if the tires and rim to rest on the lug bolts while the rum is slid on or off along the lug bolts. The threads on the lug bolts tend to abrade the inside surface of the holes in the rims like a rasp or file. Because this invention takes most of the weight of the wheel and rim off the lug bolts, while the rim is being slid into position, it eliminates most of this abrasion to the rims.

### BRIEF DESCRIPTION OF THE DRAWINGS

FIG. 1 shows a perspective view of the tire changer with a tire positioned in the cradling member and showing the tire secured by the securing device;

FIG. 2 shows a perspective view of the securing member;

FIG. 3 shows a plan view of a first end of the securing member disposed over a tire.

FIG. 4 shows a perspective view of the device without the tire in the cradling member.

FIG. 5 shows a perspective view of the tire change apparatus with a toe kicker and a brace plate.

### DETAILED DESCRIPTION

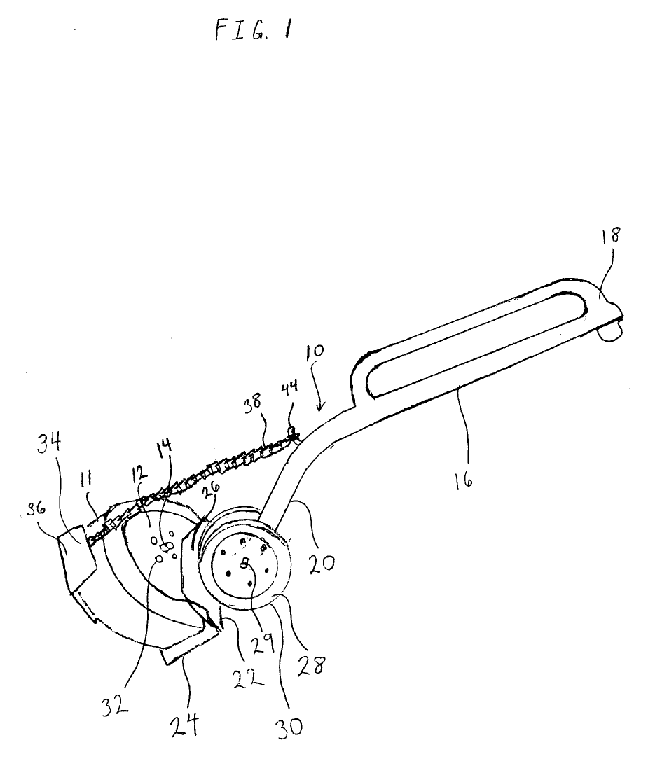

FIG. 1 depicts a portable tire changer 10 that is designed to assist both in maneuvering and in lowering and raising a tire 11 and rim 12 relative to the vehicle axle 14. The tire changer 10 comprises at least one handle 16 having a first end 18 and a second end 20. The second end 20 is attached to a cradling member 22. The cradling member 22 possesses a supporting surface 24 of adequate size and shape to support the tire 11 and rim 12 when it is being changed. In addition, the cradling member 22 possesses a backstop 26 which supports the tire 11 and rim 12 in an upright position. The tire changer 10 is supported by at least one wheel 28 on which the tire changer 10 travels. In this embodiment, two wheels 28 are depicted. The wheels 28 are disposed on either side of the handle 16, proximate to where the handle's 16 second end 20 is attached to the cradling member 22. The wheels 28 are connected to each other by an axle 29. The axle 29 is affixed to the handle 16. In this embodiment, the handle 16 is relatively narrow. This allows the wheels 28 to be disposed sufficiently proximate to each other to allow for good maneuverability of the tire changer 10, while still being sufficiently distal from each other to provide adequate stability to the tire changer 10.

The tire changer 10 rolls on the wheels 28 as the tire changer 10 transports the tire 11 and rim 12 to and from the vehicle axle 14. As depicted in this embodiment, the wheels 28, are spaced at a sufficient distance from each other to provide lateral stability to the tire changer 10. Lateral stability is especially desirable when transporting larger tires 11 and rims 12 in that it reduces the tendency of the tire changer 10 to tip under a top heavy load and therefore reduces the effort required to maneuver the tire changer 10.

The wheels 28 and axle 29 are positioned relative to the cradling member 22, such that they can serve as a fulcrum point 30 between the handle 16 and the cradling member 22. The tire changer 10 is maneuvered by holding the first end 18 of the handle 16. When the first end 18 of the handle 16 is lowered with respect to the ground, the tire changer 10 pivots at the fulcrum point 30 such that the cradling member 22 and the tire 11 and rim 12 it supports are elevated with respect to the ground. Similarly, when the first end 18 of the handle 16 is raised with respect to the ground, the tire changer 10 pivots at the fulcrum point 30 such that the cradling member 22 and the tire 11 and rim 12 it supports are depressed with respect to the ground. The ability to raise and lower the tire 11 and rim 12 assists in removing the tire 11 and rim 12 from the lug bolts 32 by taking pressure off the lug bolts 32 while the tire 11 and rim 12 are backed off of the lug bolts 32.

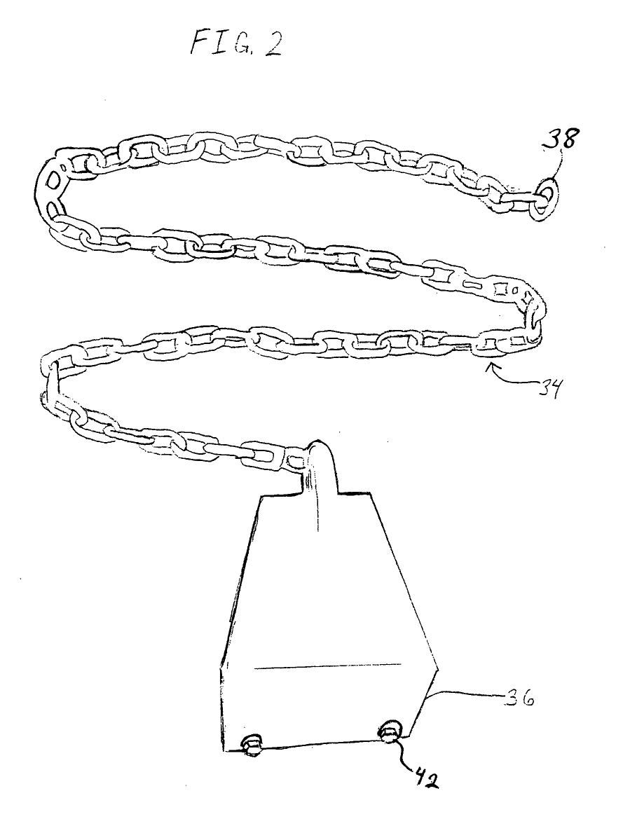

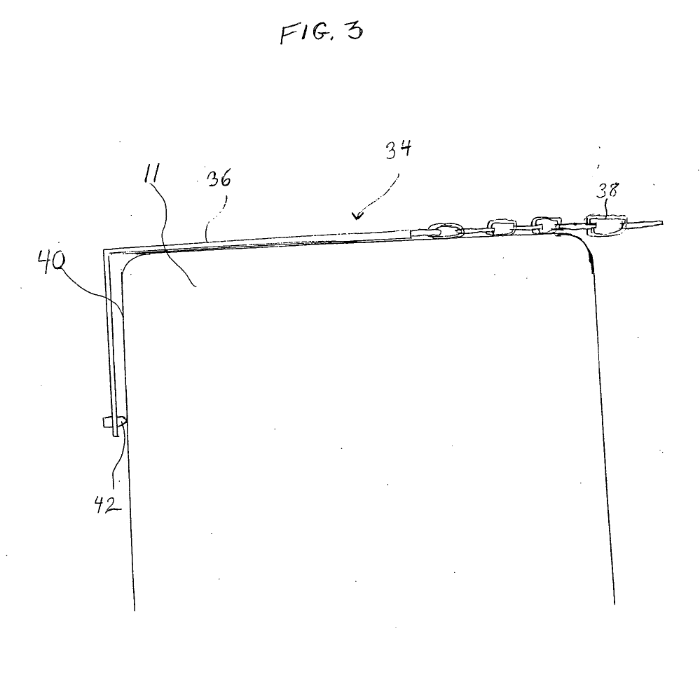

The tire changer 10 comprises at least one securing member 34. The securing member 34 is depicted in FIG. 2. The securing member 34 comprises at least on tire gripping member 36 and at least on tightening member 38. FIG. 3 depicts a plan view of the tire gripping member 36 and a partial view of the tire 11. The tire gripping member 36 engages the top outer edge 40 of the tire 11. At least one cleat 42 is affixed to the tire gripping member 36 of the securing member 34 to engage the top outer edge 40 of the tire 11. Referring to FIG. 1, the tire gripping member 36 of the securing member 34 engages the tire 11. The tightening member 38 of the securing member 34 is removably attached to the handle 16 with an attachment means 44. In this embodiment, the tightening member 38 is comprised of a chain. However, the tightening member can be can be comprise of cable, robe or any other flexible or rigid material that can serve to attach the tire gripping member to the attachment means 44. In this embodiment, the attachment means 44 comprises a hook 46 affixed to the handle 16. When the securing member 34 is fastened tightly to the attachment means 44, it causes the tire 11 to press snugly against the backstop 38 such that the tire 11 and rim 12 are snugly secured to the cradling member 22.

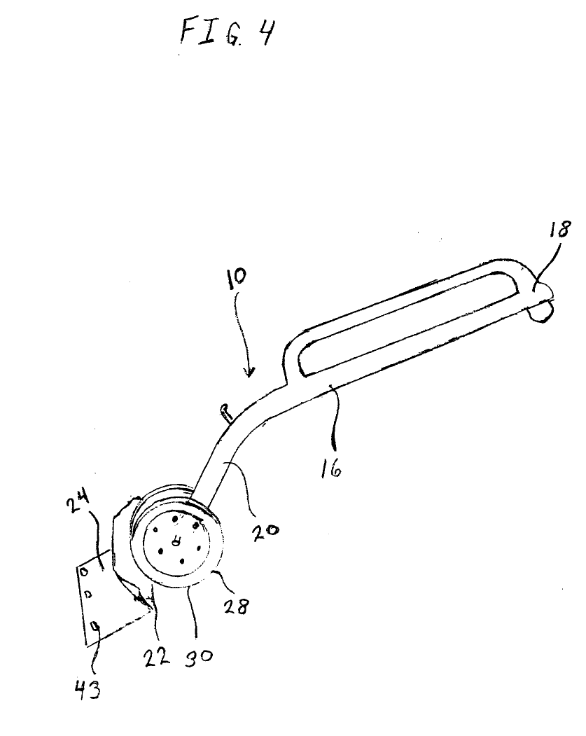

Referring to FIG. 4, at least one cleat 43 is affixed to the supporting surface 24 of the cradling member 22. The at least one cleat 43 keeps the bottom 48 of the tire 11 (FIG. 1) from kicking out when the securing member 34 is attached to the tire 11. While this embodiment utilizes a securing member 34, as an alternative embodiment, the tire changing apparatus can be effectively utilized without a securing member 34. As can be seen from this invention, it is very easy to remove a tire 11 and rim 12 from a vehicle axle 14 with the assistance of the tire changer 10 depicted in FIG. 1. To remove a tire 11 and rim 12, the cradling member 22 is maneuvered to a position directly below the tire 11. The cradling member 22 is then raised to a point where it is flush with the underside of the tire 11. The second end 34 of the securing member 34 is then fastened to the attachment means 44 in such a manner that the securing member 34 presses the tire 11 and rim 12 securely against backstop 26 of the cradling member 22. Thus, the tire 11 and rim 12 are held securely in the cradling member 22. The tire 11 and rim 12 can then be maneuvered off the lug bolts 32 and away from the vehicle axle 14 by manipulating the first end 18 of the handle 16. The replacement tire 11 and rim 12 can be similarly maneuvered into position on the vehicle axle 14.

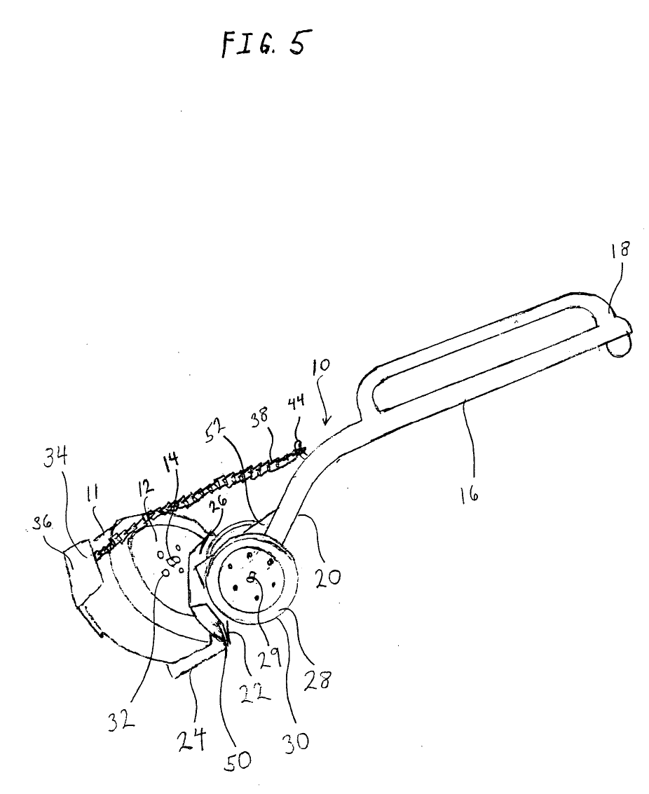

In an alternative embodiment, depicted in FIG. 5, a toe kicker 50 is affixed to the backstop 26 of the cradling member 22. The toe kicker assists in maneuvering the cradling member 22 under the tire 11. Additionally, a brace plate 52 is affixed to the handle 16 proximate to the second end 20 of the handle 16 to provide added strength to the tire changer 10.

What is claimed is:

1. A portable tire change apparatus comprising:
a handle having a first and a second end;
a cradling means located proximate to the second end of the handle for supporting a tire and rim; and
at least one wheel affixed proximate to the second end of the handle to facilitate moving the handle and a cradling member.

2. The portable tire change apparatus of claim 1, further comprising a securing member that secures the said tire and rim to the said cradling member.

3. The portable tire change apparatus of claim 1 wherein at least one cleat is affixed to a supporting surface of the said cradling member.

4. The portable tire change apparatus of claim 2, wherein at least one cleat is affixed to the said securing member.

5. A portable tire change apparatus comprising:
a handle having a first and a second end;
A cradling means located proximate to the second end of the handle for supporting a tire and rim; and
At least two wheels affixed proximate to the second end of the handle to a facilitate moving the handle and cradling means, and positioned sufficiently distal from one another to impart stability to said tire change apparatus, while at the same time, being sufficiently proximate to one another to allow maximum maneuverability of the tire change apparatus.
